(19) United States
(12) Patent Application Publication
(10) Pub. No.: US 2006/0222251 A1
(43) Pub. Date: Oct. 5, 2006

(54) Method and system for frame/field coding

(76) Inventor: Bo Zhang, Westford, MA (US)

Correspondence Address: MCANDREWS HELD & MALLOY, LTD, 500 WEST MADISON STREET, SUITE 3400, CHICAGO, IL, 60661, US

(21) Appl. No.: 11/096,468

(22) Filed: Apr. 1, 2005

(51) Int. Cl. G06K 9/36

(52) U.S. Cl. 382/239; 382/236

(57) ABSTRACT

Described herein is a system and method for encoding video data with motion estimation. The system and method can optimize memory usage and enhance the perceptual quality of an encoded picture by combining the processes in adaptive frame/field coding.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Encoded video takes advantage of spatial and temporal redundancies to achieve compression. Thorough identification of such redundancies is advantageous for reducing the size of the final output video stream. Since video sources may contain fast moving pictures or stationary pictures, the mode of compression will impact not only the size of the video stream, but also the perceptual quality of decoded pictures. Some video standards allow encoders to adapt to the characteristics of the source to achieve better compaction and better quality of service.

For example, the H.264/AVC standard allows for enhanced compression performance by adapting motion estimation to either fields or frames during the encoding process. This allowance may improve quality, but it may also increase the system requirements for memory allocation.

Limitations and disadvantages of conventional and traditional approaches will become apparent to one of ordinary skill in the art through comparison of such systems with the present invention as set forth in the remainder of the present application with reference to the drawings.

### BRIEF SUMMARY OF THE INVENTION

Described herein are system(s) and method(s) for adaptive frame/field coding of video data, substantially as shown in and/or described in connection with at least one of the figures, as set forth more completely in the claims.

These and other advantages and novel features of the present invention will be more fully understood from the following description.

### BRIEF DESCRIPTION OF THE DRAWINGS

FIG. 1 is a block diagram describing spatially encoded macroblocks;

FIG. 2 is a block diagram describing temporally encoded macroblocks;

FIG. 3 is a block diagram of frame/field encoding of macroblocks in accordance with an embodiment of the present invention;

FIG. 4 is a video encoding system in accordance with an embodiment of the present invention; and

FIG. 5 is a flow diagram of an exemplary method for video encoding in accordance with an embodiment of the present invention.

### DETAILED DESCRIPTION OF THE INVENTION

According to certain aspects of the present invention, a system and method for encoding video data with motion estimation are presented. The system and method can optimize memory usage and enhance the perceptual quality of an encoded picture.

Most video applications require the compression of digital video for transmission, storage, and data management. A video encoder performs the task of compression by taking advantage of spatial, temporal, spectral, and statistical redundancies to achieve compression.

Spatial Prediction

Spatial prediction, also referred to as intraprediction, involves prediction of picture pixels from neighboring pixels. A macroblock can be divided into partitions that contain a set of pixels. In spatial prediction, a macroblock is encoded as the combination of the prediction errors representing its partitions.

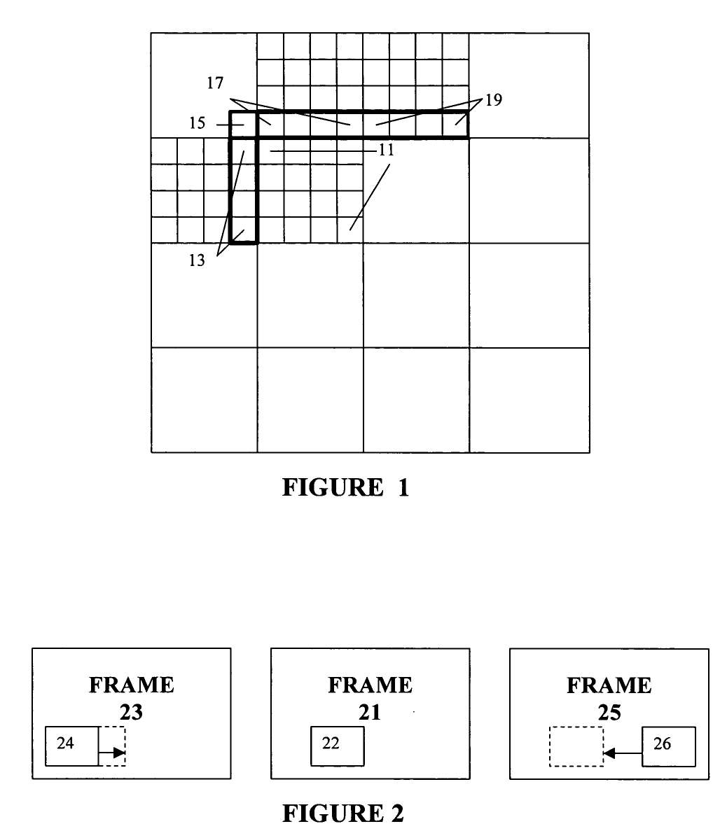

In FIG. 1, there is illustrated a block diagram illustrating spatially encoded macroblocks. In a 4×4 mode, a macroblock 11 is divided into 4×4 partitions. The 4×4 partitions of the macroblock 11 are predicted from a combination of left edge partitions 13, a corner partition 15, top edge partitions 17, and top right partitions 19. The difference between the macroblock 11 and prediction pixels in the partitions 13, 15, 17, and 19 is known as the prediction error. The prediction error is encoded along with an identification of the prediction pixels and prediction mode.

Temporal Prediction

A temporally encoded macroblock can also be divided into partitions. Each partition of a macroblock is compared to one or more prediction partitions in another picture(s). The difference between the partition and the prediction partition(s) is known as the prediction error. A macroblock is encoded as the combination of the prediction errors representing its partitions. The prediction error is encoded along with an identification of the prediction partition(s) that are identified by motion vectors. Motion vectors describe the spatial displacement between partitions.

Referring now to FIG. 2, there is illustrated a block diagram describing temporally encoded macroblocks. In bi-directional coding, a first partition 22 in a first picture 21 that is being coded is predicted from a second partition 24 in a second picture 23 and a third partition 26 in a third picture 25. Accordingly, a prediction error is calculated as the difference between the weighted average of the prediction partitions 24 and 26 and the partition 22 in a first picture 21. The prediction error and an identification of the prediction partitions are encoded. Motion vectors identify the prediction partitions.

The weights can also be encoded explicitly, or implied from an identification of the picture containing the prediction partitions. The weights can be implied from the distance between the pictures containing the prediction partitions and the picture containing the partition.

MPEG-4

ITU-H.264 is an exemplary video coding protocol that was standardized by the Moving Picture Experts Group (MPEG). H.264 is also known as MPEG-4, Part 10, and Advanced Video Coding. In the H.264 standard, video is encoded on a picture-by-picture basis, and pictures are encoded on a macroblock by macroblock basis. H.264 specifies the use of spatial prediction, temporal prediction, transformation, interlaced coding, and lossless entropy coding to compress the macroblocks. The term picture is used generically to refer to frames, fields, macroblocks, blocks, or portions thereof. To provide high coding efficiency, video coding standards such as H.264 may allow a video encoder to adapt the mode of temporal prediction (also known as motion estimation) based on the content of the video data. In H.264, the video encoder may use adaptive frame/field coding.

Macroblock Adaptive Frame/Field (MBAFF) Coding

In MBAFF coding, the coding is at the macroblock pair level. Two vertically adjacent macroblocks are split into either pairs of two field or frame macroblocks. For a macroblock pair that is coded in frame mode, each macroblock contains frame lines. For a macroblock pair that is coded in field mode, the top macroblock contains top field lines and the bottom macroblock contains bottom field lines. Since a mixture of field and frame macroblock pairs may occur within an MBAFF frame, encoding processes such as transformation, estimation, and quantization are modified to account for this mixture.

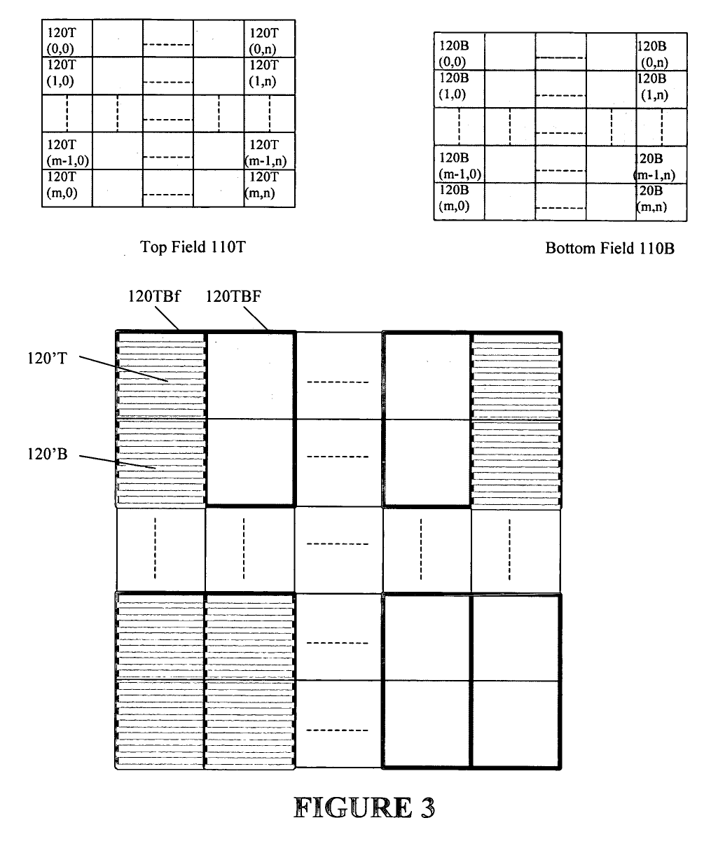

Referring now to FIG. 3, there is illustrated a block diagram describing the encoding of macroblocks 120 for interlaced fields. As noted above, interlaced fields, top field 110T(x,y) and bottom field 110B(x,y) represent either even or odd-numbered lines.

In MBAFF, each macroblock 120T in the top frame is paired with the macroblock 120B in the bottom frame that is interlaced with it. The macroblocks 120T and 120B are then coded as a macroblock pair 120TB. The macroblock pair 120TB can either be field coded, i.e., macroblock pair 120TBF or frame coded, i.e., macroblock pair 120TBf. Where the macroblock pair 120TBF are field coded, the macroblock 120T is encoded, followed by macroblock 120B. Where the macroblock pair 120TBf are frame coded, the macroblocks 120T and 120B are deinterlaced. The foregoing results in two new macroblocks 120′T, 120′B. The macroblock 120′T is encoded, followed by macroblock 120′B.

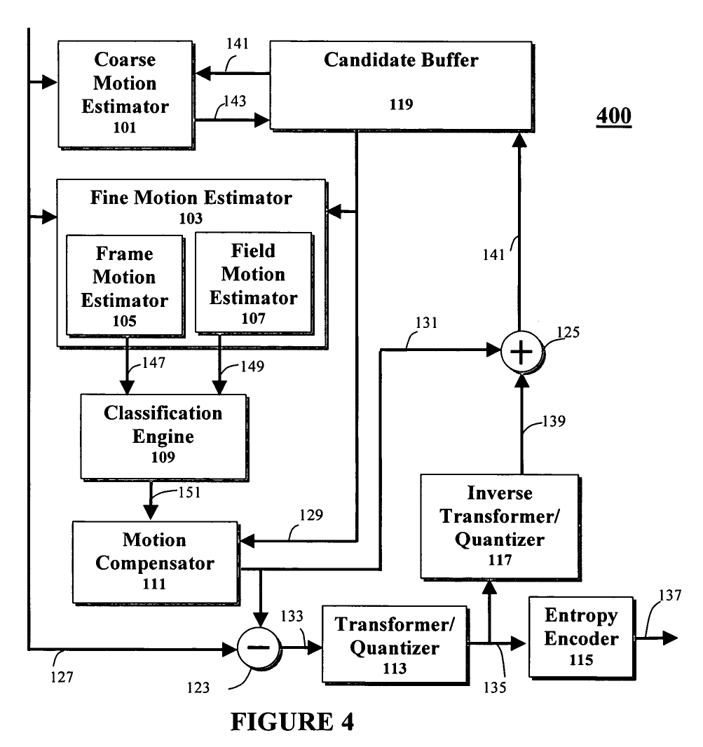

FIG. 4 is a video encoding system 400 in accordance with an embodiment of the present invention. When video data 127 is presented for encoding, the video encoding system 400 processes in units of macroblocks. The term current picture is used generically to refer the macroblock currently presented for encoding, and the term reference picture is used generically to refer a macroblock that was previously encoded. The video encoding system 400 comprises a coarse motion estimator 101, a fine motion estimator 103, a classification engine 109, a motion compensator 111, a transformer/quantizer 113, an entropy encoder 115, an inverse transformer/quantizer 117, and a candidate buffer 119. The foregoing can comprise hardware accelerator units under the control of a CPU.

The motion vector(s) 151 selected by the classification engine 109 along with a candidate picture set 129 are used by the motion compensator 111 to produces a video input prediction 131. The classification engine 109 and candidate picture set 129 are described in further detail later. A subtractor 123 may be used to compare the video input prediction 131 to a current picture 127, resulting in a prediction error 133. The transformer/quantizer 113 transforms and quantizes the prediction error 133, resulting in a set of quantized transform coefficients 135. The entropy encoder 115 encodes the coefficients to produce a video output 137. Additionally, the motion vectors 151 that identify the reference block are sent to the transformer/quantizer 113 and the entropy encoder 115.

The video encoding system 400 also decodes the quantized transform coefficients, via the inverse transformer/quantizer 117. The decoded transform coefficients 139 may be added 125 to the video input prediction 131 to generate a set of reference pictures 141 that are stored in the candidate buffer 119.

The coarse motion estimator 101 receives the set of reference pictures 141 and determines the candidate picture set 129 that will be maintained and possibly used for subsequent processes. The coarse motion estimator 101 will send a control signal 143 that indicates the candidate picture set 129. This indication is based on the likelihood that a reference picture can be used in field mode motion estimation. This evaluation is permissive enough that candidate pictures for both field mode motion estimation and frame mode motion estimation are maintained. All other pictures may be removed or overwritten. Thus, memory usage is optimized early in the motion estimation process.

The current picture 127 and the candidate picture set 129 are passed to the fine motion estimator 103 that comprises a frame motion estimator 105 producing one or more frame motion vectors 147 and a field mode motion estimator 107 producing one or more frame motion vectors 149. In the field motion estimator 107, the picture elements of one field are predicted only from pixels of reference fields corresponding to that one field.

The frame motion vector(s) 147 and field motion vector(s) 149 are directed to the input of the classification engine 109 that makes a decision as to the type of motion estimation. The motion vector(s) 151 that are selected form an input to the motion compensator 111.

The choice between the frame estimation and field estimation can be made for a macroblock pair or a group of macroblocks. The estimation mode can be based on encoding cost relative to motion in the picture. In interlaced frames with regions of moving objects or camera motion, two adjacent rows tend to show a reduced degree of statistical dependency. If the difference between adjacent rows is less than the difference between alternate rows, the picture may be more stationary and frame mode could be selected. Likewise if the difference between adjacent rows is greater than the difference between alternate odd and even rows, the picture may be moving and field mode could be selected.

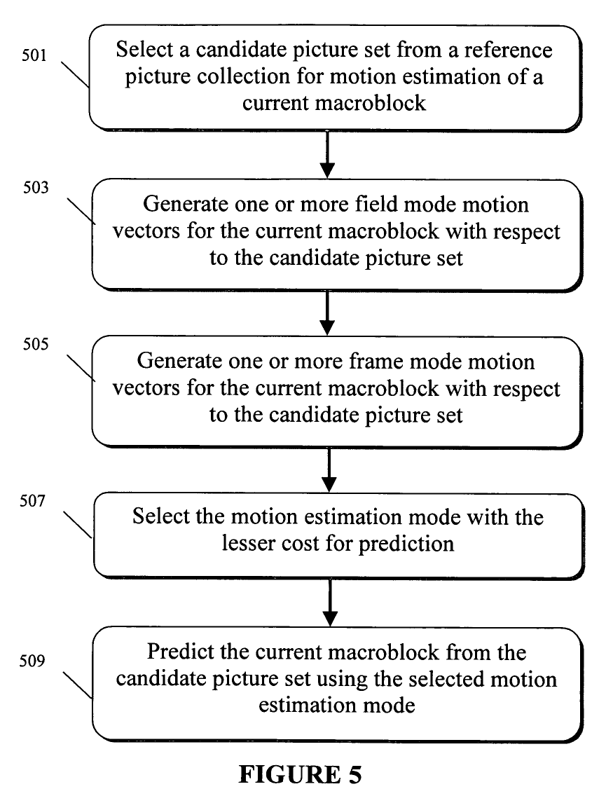

FIG. 5 is a flow diagram of an exemplary method for video encoding. Video data is typically encoded in units of macroblocks. The term current picture is used generically to refer the macroblock currently presented for encoding, and the term reference picture is used generically to refer a macroblock that was previously encoded. A video output is produced by entropy encoding a set of quantized transform coefficients. The quantized transform coefficients are also used in the reconstruction of a reference picture. Over time a collection of reference pictures is stored. A coarse motion estimator selects a portion of the reference picture collection for motion estimation of a current macroblock 501. This portion will be called the candidate picture set. The selection is based on a field mode of motion estimation and is permissive enough that candidate pictures for both field mode motion estimation and frame mode motion estimation are maintained. The reference pictures that were not selected may be overwritten or removed from memory. Thus, memory usage is optimized early in the motion estimation process.

The current picture and the candidate picture set are passed to a fine motion estimator that comprises a frame motion estimator and a field mode motion estimator. The field mode motion estimator generates one or more field mode motion vectors for the current macroblock with respect to the candidate picture set 503. In the field motion estimator, the picture elements of one field are predicted only from pixels of reference fields corresponding to that one field. The frame mode motion estimator generates one or more frame mode motion vectors for the current macroblock with respect to the candidate picture set 505. The frame motion vector(s) and field motion vector(s) are directed to the input of a classification engine that makes a decision as to the type of motion estimation. A cost for predicting using the frame mode motion vectors is compared with a cost for predicting using the field mode motion vectors and the mode with the lesser cost is selected to be a preferred motion estimation mode 507. The cost for frame or field motion estimation can be based on the size of the corresponding motion vector set and/or the size of the difference between the current picture and the current picture estimate. These sizes may be based on the estimated number of bits in the output if a mode is selected. The estimation mode can be based on encoding cost relative to motion in the picture. In interlaced frames with regions of moving objects or camera motion, two adjacent rows tend to show a reduced degree of statistical dependency. If the difference between adjacent rows is less than the difference between alternate rows, the picture may be more stationary and frame mode could be selected. Likewise if the difference between adjacent rows is greater than the difference between alternate odd and even rows, the picture may be moving and field mode could be selected.

Once a mode is selected, the current picture is predicted based on the actual motion estimation mode with respect to the candidate picture set 509. The motion vector(s) of the actual motion estimation mode form an input to a motion compensator/predictor. The motion compensator/predictor produces a current picture estimate. The comparison between the current picture and current picture estimate is a prediction error. A transformer/quantizer processes the prediction error, resulting in a video output.

The embodiments described herein may be implemented as a board level product, as a single chip, application specific integrated circuit (ASIC), or with varying levels of a video classification circuit integrated with other portions of the system as separate components.

The degree of integration of the video encoding system will primarily be determined by the speed and cost considerations. Because of the sophisticated nature of modern processors, it is possible to utilize a commercially available processor, which may be implemented external to an ASIC implementation.

If the processor is available as an ASIC core or logic block, then the commercially available processor can be implemented as part of an ASIC device wherein certain functions can be implemented in firmware as instructions stored in a memory. Alternatively, the functions can be implemented as hardware accelerator units controlled by the processor.

While the present invention has been described with reference to certain embodiments, it will be understood by those skilled in the art that various changes may be made and equivalents may be substituted without departing from the scope of the present invention.

Additionally, many modifications may be made to adapt a particular situation or material to the teachings of the present invention without departing from its scope. For example, although the invention has been described with a particular emphasis on MPEG-4 encoded video data, the invention can be applied to a video data encoded with a wide variety of standards.

Therefore, it is intended that the present invention not be limited to the particular embodiment disclosed, but that the present invention will include all embodiments falling within the scope of the appended claims.

1. A method for video encoding, said method comprising:
selecting a candidate picture set from a set of reference pictures, wherein the selection is based on a field motion estimation of a current picture;
determining a cost for field motion estimation in the current picture with respect to the candidate picture set;
determining a cost for frame motion estimation in the current picture with respect to the candidate picture set; and
selecting a preferred motion estimation mode based on the cost for field motion estimation and the cost for frame motion estimation.

2. The method of claim 1, wherein determining a cost for field motion estimation further comprises:
generating a field motion vector set for the current picture with respect to the candidate picture set; and
determining the cost for field motion estimation based on a size of the field motion vector set.

3. The method of claim 2, wherein determining a cost for field motion estimation further comprises:
generating a current picture estimate from the field motion vector set with respect to the candidate picture set; and
determining the cost for field motion estimation based on a difference between the current picture and the current picture estimate.

4. The method of claim 1, wherein determining a cost for frame motion estimation further comprises:
generating a frame motion vector set for the current picture with respect to the candidate picture set; and
determining the cost for frame motion estimation based on a size of the frame motion vector set.

5. The method of claim 4, wherein determining a cost for frame motion estimation further comprises:
generating a current picture estimate from the frame motion vector set with respect to the candidate picture set; and
determining the cost for frame motion estimation based on a difference between the current picture and the current picture estimate.

6. The method of claim 1, wherein the preferred motion estimation mode of the current macroblock is used for another macroblock.

7. A video encoder with motion estimation, said video encoder comprising:
a coarse motion estimator for selecting a plurality of candidate pictures for motion estimation of a field in a current macroblock;
a fine motion estimator for computing two or more motion vectors for the current macroblock with respect to the plurality of candidate pictures, wherein the motion vectors comprise at least one field mode motion vector and at least one frame mode motion vector; and
a classification engine for selecting a motion estimation mode based on the motion vectors, wherein the motion estimation mode is selected from a set containing a frame mode and a field mode.

8. The video encoder of claim 7, wherein the video encoder further comprises memory for storing the plurality of candidate pictures.

9. The video encoder of claim 7, wherein the classification engine further comprises:
determining a cost for motion estimation based on a size of the motion vectors.

10. The video encoder of claim 7, wherein the classification engine further comprises:
generating a current picture estimate with respect to the candidate picture set, wherein the estimate is based on at least one motion vector in the motion vector set; and
determining the cost for motion estimation based on a difference between the current picture and the current picture estimate.

11. A integrated circuit for video encoding with motion estimation, said integrated circuit comprising:
arithmetic logic operable to select a plurality of candidate pictures, wherein said plurality of candidate pictures is used to generate one or more frame mode motion vectors and one or more field mode motion vectors; and
memory for storing the plurality of candidate pictures.

12. The integrated circuit of claim 11, wherein the arithmetic logic is further operable to select an estimation mode based on a prediction error of the frame mode motion vectors and a prediction error of the field mode motion vectors.
